(19) United States
(12) Patent Application Publication
(10) Pub. No.: US 2024/0340902 A1
(43) Pub. Date: Oct. 10, 2024

(54) TIMING ADVANCE DETERMINATION FOR UPLINK CONTROL CHANNEL WITH JOINT ACKNOWLEDGEMENT FEEDBACK FOR NETWORK OPERATIONS HAVING MULTIPLE TIMING ADVANCE GROUPS CONFIGURED PER SERVING CELL AND MULTIPLE CONTROL RESOURCE SETS CONFIGURED PER BANDWIDTH PART

(71) Applicant: QUALCOMM Incorporated, San Diego, CA (US)

(72) Inventors: Shaozhen Guo, Beijing (CN); Mostafa Khoshnevisan, San Diego, CA (US); Fang Yuan, Beijing (CN); Jing Sun, San Diego, CA (US); Xiaoxia Zhang, San Diego, CA (US); Yan Zhou, San Diego, CA (US); Tao Luo, San Diego, CA (US)

(21) Appl. No.: 18/718,715

(22) PCT Filed: Feb. 10, 2022
(86) PCT No.: PCT/CN2022/075829

§ 371 Date: Jun. 11, 2024

(51) Int. Cl. H04W 72/20; H04L 1/1607; H04L 5/00; H04W 72/1273

(52) U.S. Cl. CPC H04W 72/20; H04L 1/1607; H04L 5/0053; H04W 72/1273

(57) ABSTRACT

Wireless communication capabilities are disclosed that support determination of timing advance for a physical uplink control channel (PUCCH) in joint acknowledgement feedback mode of a network having multiple timing advance groups (TAGs) configured per serving cell and multiple control resource set (CORESET) pool index values configured per bandwidth part (BWP). In a first aspect, a method of such capabilities includes receiving a configuration message including at least a feedback mode configuration configuring a joint acknowledgement feedback mode, a TAG configuration for each serving cell, and any CORESET pool indices for the BWPs of the serving cells. A user equipment (UE) receives downlink transmissions and determines a timing advance for a PUCCH with a joint acknowledgement message using the last downlink control information (DCI) message received scheduling the downlink transmissions. Alternatively, a UE may use a predetermined timing advance. Other aspects and features are also claimed and described.

### TECHNICAL FIELD

Aspects of the present disclosure relate generally to wireless communication systems, and more particularly, to uplink communications in a network operation having multiple timing advance groups (TAGs) configured per serving cell and multiple control resource sets (CORESET) pool index values configured per bandwidth part (BWP). Some features may enable and provide improved communications, including determination of timing advance (TA) for a physical uplink control channel (PUCCH) in a joint acknowledgement feedback mode.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes receiving, by a user equipment (UE), a radio resource configuration message, wherein the radio resource configuration message includes at least: a feedback mode configuration configuring a joint acknowledgement (ACK)/negative acknowledgement (NACK) feedback mode, a timing advance group (TAG) configuration for each serving cell of a plurality of serving cells, wherein at least one serving cell of the plurality of serving cells is configured with a plurality of TAGs, and one of: zero control resource set (CORESET) pool index value and a second CORESET pool index for second CORESETs configured on one or more active bandwidth parts (BWPs) of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The method further includes receiving, by the UE, one or more downlink transmissions via one or more downlink resources, wherein each of the one or more downlink transmissions is scheduled by a downlink control information (DCI) message and subject to the joint ACK/NACK feedback mode, determining, by the UE, a timing advance (TA) for a physical uplink control channel (PUCCH) using a determining DCI message, wherein the determining DCI message corresponds to the DCI message received last in time of the DCI message scheduling each of the one or more downlink transmissions, and transmitting, by the UE, the PUCCH including a joint ACK/NACK message using the TA, wherein the joint ACK/NACK message includes acknowledgement feedback information for each of the one or more downlink transmissions.

In an additional aspect of the disclosure, a method of wireless communication includes receiving, by a UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The method further includes receiving, by the UE, one or more downlink transmissions subject to the joint ACK/NACK feedback mode via one or more downlink resources, determining, by the UE, a TA for a PUCCH using a predetermined TAG of the plurality of TAGs, and transmitting, by the UE, the PUCCH including a joint ACK/NACK message using the TA, wherein the joint ACK/NACK message includes acknowledgement feedback information for each of the one or more downlink transmissions.

In an additional aspect of the disclosure, a UE configured for wireless communication is disclosed. The UE includes at least one processor, and a memory coupled to the at least one processor. The at least one processor is configured to receive, by a UE, a radio resource configuration message, wherein the radio resource configuration message includes at least: a feedback mode configuration configuring a joint ACK/NACK feedback mode, a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The at least one processor is further configured to receive, by the UE, one or more downlink transmissions via one or more downlink resources, wherein each of the one or more downlink transmissions is scheduled by a DCI message and subject to the joint ACK/NACK feedback mode, to determine, by the UE, a TA for a PUCCH using a determining DCI message, wherein the determining DCI message corresponds to the DCI message received last in time of the DCI message scheduling each of the one or more downlink transmissions, and to transmit, by the UE, the PUCCH including a joint ACK/NACK message using the TA, wherein the joint ACK/NACK message includes acknowledgement feedback information for each of the one or more downlink transmissions.

In an additional aspect of the disclosure, a UE configured for wireless communication is disclosed. The UE includes at least one processor, and a memory coupled to the at least one processor. The at least one processor is configured to receive, by the UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The at least one processor is further configured to receive, by the UE, one or more downlink transmissions subject to the joint ACK/NACK feedback mode via one or more downlink resources, to determine, by the UE, a TA for a PUCCH using a predetermined TAG of the plurality of TAGs, and to transmit, by the UE, the PUCCH including a joint ACK/NACK message using the TA, wherein the joint ACK/NACK message includes acknowledgement feedback information for each of the one or more downlink transmissions.

In an additional aspect of the disclosure, a UE configured for wireless communication is disclosed. The UE includes means for receiving, by a UE, a radio resource configuration message, wherein the radio resource configuration message includes at least: a feedback mode configuration configuring a joint ACK/NACK feedback mode, a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The UE further includes means for receiving, by the UE, one or more downlink transmissions via one or more downlink resources, wherein each of the one or more downlink transmissions is scheduled by a DCI message and subject to the joint ACK/NACK feedback mode, means for determining, by the UE, a TA for a PUCCH using a determining DCI message, wherein the determining DCI message corresponds to the DCI message received last in time of the DCI message scheduling each of the one or more downlink transmissions, and means for transmitting, by the UE, the PUCCH including a joint ACK/NACK message using the TA, wherein the joint ACK/NACK message includes acknowledgement feedback information for each of the one or more downlink transmissions.

In an additional aspect of the disclosure, a UE configured for wireless communication is disclosed. The UE includes means for receiving, by the UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The UE further includes means for receiving, by the UE, one or more downlink transmissions subject to the joint ACK/NACK feedback mode via one or more downlink resources, means for determining, by the UE, a TA for a PUCCH using a predetermined TAG of the plurality of TAGs, and means for transmitting, by the UE, the PUCCH including a joint ACK/NACK message using the TA, wherein the joint ACK/NACK message includes acknowledgement feedback information for each of the one or more downlink transmissions.

In an additional aspect of the disclosure, a non-transitory computer-readable medium stores instructions that, when executed by a processor, cause the processor to perform operations including receiving, by a UE, a radio resource configuration message, wherein the radio resource configuration message includes at least: a feedback mode configuration configuring a joint ACK/NACK feedback mode, a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The non-transitory computer-readable medium further stores instructions that, when executed by a processor, cause the processor to perform operations including receiving, by the UE, one or more downlink transmissions via one or more downlink resources, wherein each of the one or more downlink transmissions is scheduled by a DCI message and subject to the joint ACK/NACK feedback mode, determining, by the UE, a TA for a PUCCH using a determining DCI message, wherein the determining DCI message corresponds to the DCI message received last in time of the DCI message scheduling each of the one or more downlink transmissions, and transmitting, by the UE, the PUCCH including a joint ACK/NACK message using the TA, wherein the joint ACK/NACK message includes acknowledgement feedback information for each of the one or more downlink transmissions.

In an additional aspect of the disclosure, a non-transitory computer-readable medium stores instructions that, when executed by a processor, cause the processor to perform operations including receiving, by the UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The non-transitory computer-readable medium further stores instructions that, when executed by a processor, cause the processor to perform operations including receiving, by the UE, one or more downlink transmissions subject to the joint ACK/NACK feedback mode via one or more downlink resources, determining, by the UE, a TA for a PUCCH using a predetermined TAG of the plurality of TAGs, and transmitting, by the UE, the PUCCH including a joint ACK/NACK message using the TA, wherein the joint ACK/NACK message includes acknowledgement feedback information for each of the one or more downlink transmissions.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a block diagram illustrating a serving cell served by base stations and having at least one CC/BWP configured with multiple CORESET pool index values.

FIG. 4 is a flow diagram illustrating an example process that supports determination of timing advance for a PUCCH in a joint acknowledgement feedback mode of a network having multiple TAGs configured per serving cell and multiple CORESET pool index values configured per BWP according to one or more aspects.

FIG. 5 is a block diagram illustrating wireless network 50 that supports determination of timing advance for a PUCCH in a joint acknowledgement feedback mode of a network having multiple TAGs configured per serving cell and multiple CORESET pool index values configured per BWP according to one or more aspects.

FIG. 6 is a flow diagram illustrating an example process 600 that supports determination of timing advance for a PUCCH in a joint acknowledgement feedback mode of a network having multiple TAGs configured per serving cell and multiple CORESET pool index values configured per BWP according to one or more aspects.

FIG. 7 is a block diagram illustrating wireless network 70 that supports determination of timing advance for a PUCCH in a joint acknowledgement feedback mode of a network having multiple TAGs configured per serving cell and multiple CORESET pool index values configured per BWP according to one or more aspects.

FIG. 8 is a block diagram of an example UE that supports determination of timing advance for a PUCCH in a joint acknowledgement feedback mode of a network having multiple TAGs configured per serving cell and multiple CORESET pool index values configured per BWP to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support determination of timing advance for a physical uplink control channel (PUCCH) in a joint acknowledgement feedback mode of a network having multiple timing advance groups (TAGs) configured per serving cell and multiple control resource sets (CORESET) pool index values configured per bandwidth part (BWP). Particular implementations of the subject matter described in this disclosure may be implemented to realize one or more of the following potential advantages or benefits. In some aspects, the present disclosure provides techniques for determining timing advance for a PUCCH in a joint acknowledgement feedback mode of a network having multiple TAGs configured per serving cell and multiple CORESET pool index values configured per BWP. Such techniques all UE acknowledgement information to be transmitted more efficiently when operating in a joint ACK/NACK mode in a serving cell having multiple TAGs configured per serving cell and multiple CORESET pool index values configured per BWP/CC.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “mmW” band.

The frequencies between FR1 and FR2 are often referred to as mid-band frequencies. Recent 5G NR studies have identified an operating band for these mid-band frequencies as frequency range designation FR3 (7.126 GHz-24.25 GHZ). Frequency bands falling within FR3 may inherit FR1 characteristics and/or FR2 characteristics, and, thus, may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2x (52.6 GHz-71 GHz), FR4 (71 GHz-114.25 GHZ), and FR5 (114.25 GHz-275 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmW” or the like if used herein may broadly represent frequencies that may include mid-band frequencies, may be within FR2, FR2x, FR4, and/or FR5, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmW transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmW components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

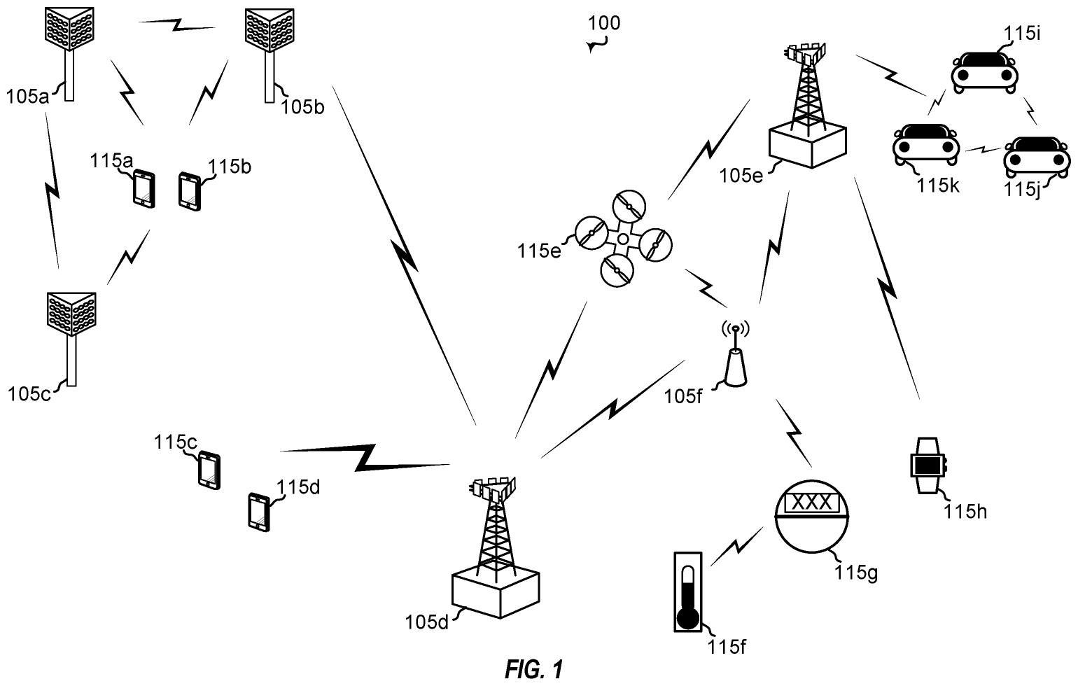

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

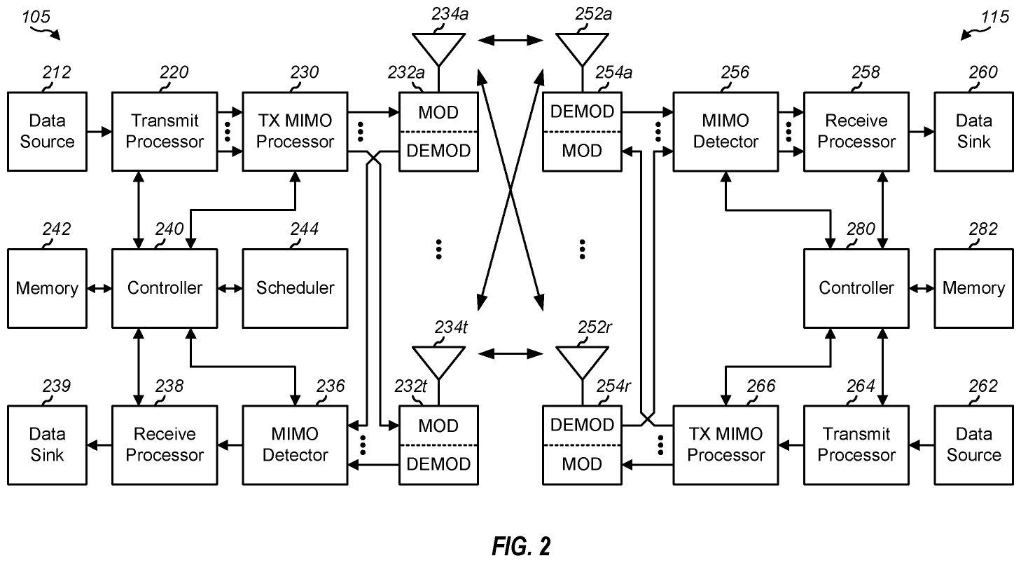

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

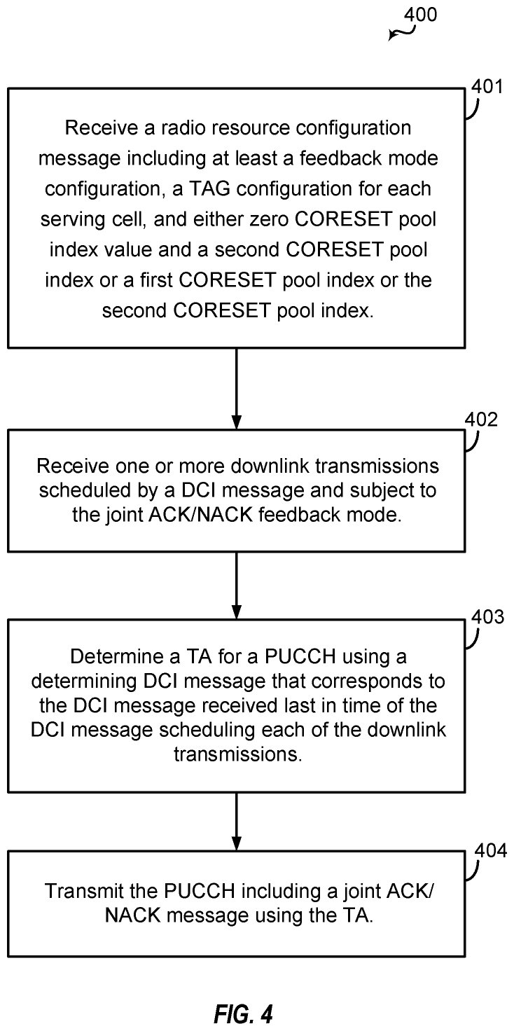

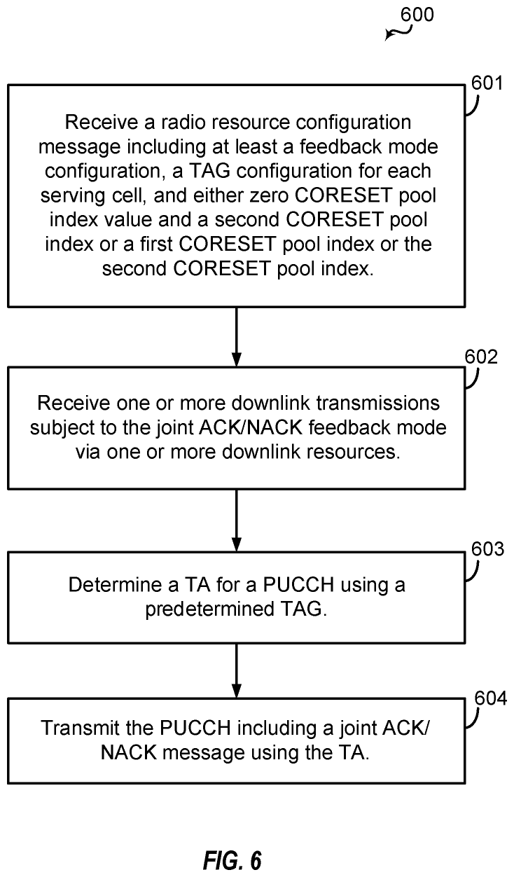

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 4 and 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, a 16-μs, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Sensing for shared channel access may also be categorized into either full-blown or abbreviated types of LBT procedures. For example, a full LBT procedure, such as a CAT 3 or CAT 4 LBT procedure, including extended channel clearance assessment (ECCA) over a non-trivial number of 9-μs slots, may also be referred to as a “Type 1 LBT.” An abbreviated LBT procedure, such as a CAT 2 LBT procedure, which may include a one-shot CCA for 16-μs or 25-μs, may also be referred to as a “Type 2 LBT.”

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

5G NR operations may provide a plurality of serving cells, in which each serving cell may be configured having multiple component carriers (CCs) or bandwidth parts (BWPs) for serving a UE within the associated serving cell and in which each serving cell may be served by multiple base stations, such that each CC or BWP may be configured with multiple control resource sets (CORESETs). When such UE receives a downlink control information (DCI) and downlink transmissions from multiple base stations within the serving cell, multiple timing advances may be defined for uplink transmissions from the UE. 3GPP Release 16 (Rel. 16) has also defined two acknowledgement feedback modes for such operations. In a separate acknowledgement feedback mode, the UE would provide any acknowledgement (ACK) or negative acknowledgement (NACK) feedback to the base station from which the downlink transmission is received. In a joint acknowledgement feedback mode, the UE transmits a single physical uplink control channel (PUCCH) to one base station that carries the ACK/NACK feedback for each downlink transmission.

It may not be practical to maintain a timing advance for each serving cell. Instead, it would make sense to group a set of collocated serving cells, so that, the same timing advance would be maintained across all the serving cells belonging to that group. The concept of a timing advance group (TAG) was introduced that includes one or more serving cells that would have the same uplink timing advance and the same downlink timing reference cell. Each such TAG may then contain a timing advance for at least one serving cell with configured uplink resources. Each such serving cell may be mapped to a particular TAG using radio resource control (RRC) signaling.

In the 3GPP NR standards, the term “spatial quasi co-location” (spatial QCL) may be used to refer to a relationship between the antenna port(s) of two different downlink reference signals transmitted by a base station. If two transmitted downlink reference signals are spatially QCL at the UE receiver, then the UE may assume that the first and second reference signals are transmitted with approximately the same transmit spatial filter configuration. Based on this assumption, the UE can use approximately the same receive spatial filter configuration to receive the second reference signal as it used to receive the first reference signal. In this way, spatial QCL assists in the use of analog beamforming and formalizes the concept of a same UE receive beam over different time instances.

While a spatial QCL refers to a relationship between two different downlink reference signals from a UE perspective, the term “spatial relation” may be used to refer to a relationship between an uplink reference signal (e.g., PUCCH, PUSCH, DMRS, etc.) and another reference signal, which can be either a downlink reference signal (e.g., CSI-RS or SSB) or an uplink reference signal (e.g., SRS). Like spatial QCL, spatial relation is also defined from a UE perspective. If the uplink reference signal is spatially related to a downlink reference signal, the UE should be capable of transmitting the uplink reference signal in the opposite or reciprocal direction from which it received the second reference signal previously. More precisely, the UE may apply substantially the same transmit spatial filtering configuration for the transmission of the first reference signal as the receive spatial filtering configuration it used to receive the second reference signal previously. If the second reference signal is an uplink reference signal, then the UE should be capable of applying the same transmit spatial filtering configuration for the transmission of the first reference signal as the transmit spatial filtering configuration it used to transmit the second reference signal previously.

3GPP Technical Specifications (TS) 38.213 and 38.331 specify that, for NR, a UE can be configured via radio resource control (RRC) messaging with a list of up to 64 spatial relations for PUCCH. This list is given by the RRC parameter PUCCH_SpatialRelationInfo. For example, the list would typically contain the identifiers (IDs) of a number of synchronization signal blocks (SSBs) and/or CSI-RS resources used for the purposes of downlink beam management. Alternatively, if SRS-based uplink beam management is employed in the network, then the list may also contain the IDs of a number of SRS resources. Each such spatial relation may be associated with a closed-loop index, which is used in uplink power control at a UE. The spatial relation may be instructive for distinguishing base stations in a multiple base station configuration.

Based on the downlink or uplink beam management measurements performed by the UE or base station, respectively, the base station may select one of the reference signal IDs from the list of configured IDs in the RRC parameter, PUCCH_SpatialRelationInfo. The selected spatial relation can be indicated via a medium access control-control element (MAC-CE) message signaled to the UE for a given PUCCH resource. The UE can then use the signaled spatial relation for the purposes of adjusting the transmit spatial filtering configuration for the transmission on that PUCCH resource. The relevant MAC-CE message may contain information, such as the ID of the PUCCH resource and an indicator of which of the configured spatial relations are selected in the RRC message, via the RRC parameter, PUCCH_SpatialRelationInfo.

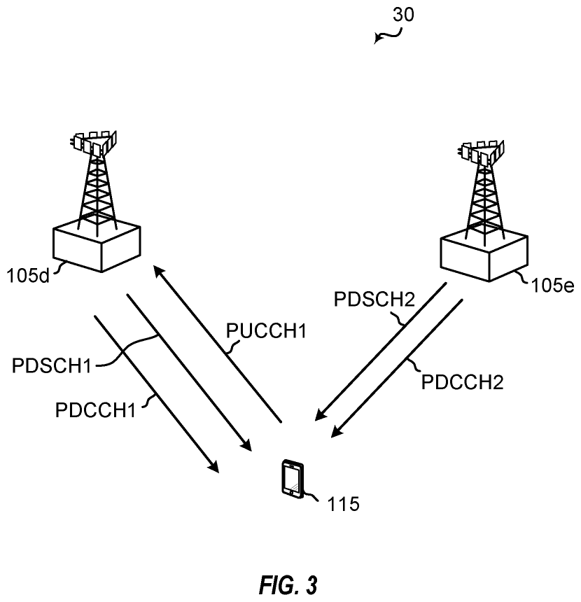

FIG. 3 is a block diagram illustrating serving cell 30 served by base stations 105d and 105e and having at least one CC/BWP configured with multiple CORESET pool index values. UE 115 may be configured with a joint ACK/NACK feedback mode. In operation, UE 115 receives a DCI from base station 105d and 105e scheduling downlink transmissions, PDSCH1 and PDSCH2, respectively. UE 115 will determine ACK/NACK feedback for each of the downlink transmissions and prepare a single uplink transmission, PUCCH1, including both sets of ACK/NACK feedback. However, within serving cell 30, because base stations 105d and 105e are in different geographic locations, multiple timing advances are configured which UE 115 will use depending on which base station its uplink transmissions are targeted. When joint ACK/NACK feedback is configured and multiple timing advances are configured for a primary cell (Pcell) or PUCCH secondary cell (PScell), UE 115 must have a means to determine which timing advance for transmission of PUCCH1 with joint ACK/NACK feedback.

FIG. 4 is a flow diagram illustrating an example process 400 that supports determination of timing advance for a PUCCH in a joint acknowledgement feedback mode of a network having multiple TAGs configured per serving cell and multiple CORESET pool index values configured per BWP according to one or more aspects. Operations of process 400 may be performed by a UE, such as UE 115 described above with reference to FIG. 1, 2, or 8. For example, example operations (also referred to as “blocks”) of process 400 may enable UE 115 to support determination of timing advance for a PUCCH in a joint acknowledgement feedback mode of a network having multiple TAGs configured per serving cell and multiple CORESET pool index values configured per BWP.

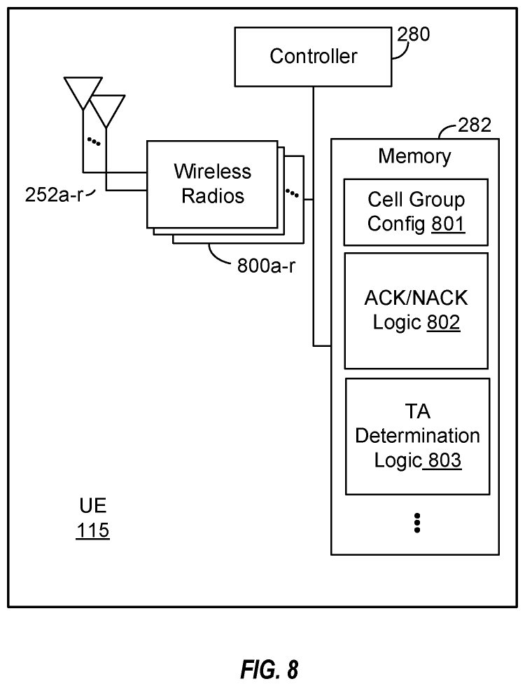

Process 400 may be described with respect to FIG. 8. FIG. 8 is a block diagram of an example UE 115 that supports determination of timing advance for a PUCCH in a joint acknowledgement feedback mode of a network having multiple TAGs configured per serving cell and multiple CORESET pool index values configured per BWP to one or more aspects. UE 115 may be configured to perform operations, including the blocks of a process described with reference to FIGS. 4 and 6. In some implementations, UE 115 includes the structure, hardware, and components shown and described with reference to UE 115 of FIGS. 1-2. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 800a-r and antennas 252a-r. Wireless radios 800a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include cell group configuration 801, ACK/NACK logic 802, and TA determination logic 803. Cell group configuration 801 corresponds to the configuration information received at UE 115 regarding the current cell group. ACK/NACK logic 802 includes the code and instructions for implementation of the downlink transmission acknowledgement operations, such as hybrid automatic receipt request (HARQ) acknowledgement operations. TA determination logic 802 includes the code and instructions to implement the functionality for UE 115 to select a timing advance for a PUCCH that includes a joint ACK/NACK message within a network having multiple TAGs configured per serving cell and multiple CORESET pool index values configured per BWP. UE 115 may receive signals from or transmit signals to one or more network entities, such as base station 105 of FIGS. 1-2, 5, and 7.

At block 401, a UE receives a radio resource configuration message, wherein the radio resource configuration message includes at least a feedback mode configuration configuring a joint ACK/NACK feedback mode, a TAG configuration for each serving cell of a plurality of serving cells, wherein at least one serving cell of the plurality of serving cells is configured with a plurality of TAGs, and either zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. A UE, such as UE 115, receives the radio resource configuration message via antennas 252a-r and wireless radios 800a-r and stores this configuration information, including the joint ACK/NACK feedback mode, TAG configuration, and any CORESET pool indices, at cell group configuration 801 in memory 280.

At block 402, the UE receives one or more downlink transmissions via one or more downlink resources, wherein each of the one or more downlink transmissions is scheduled by a DCI message and subject to the joint ACK/NACK feedback mode. UE 115 may receive downlink transmissions via a serving cell, such as through PDSCH. A base station of the serving cell may initiate the downlink transmission by providing control signaling via PDCCH, including a DCI message. The DCI message informs UE 115 of the downlink transmission schedule as well as provides additional configuration information for identifying downlink and uplink resources, as well as for transmit power control of uplink transmissions by UE 115.

At block 403, the UE determines a timing advance for a PUCCH using a determining DCI message, wherein the determining DCI message corresponds to the DCI message received last in time of the DCI message scheduling each of the one or more downlink transmissions. UE 115, under control of controller 380, executes TA determination logic 803, in memory 282. The execution of TA determination logic 803 (referred to as the “execution environment” of TA determination logic 803) implements the functionality of UE 115 for determination of a timing advance for a PUCCH in a joint acknowledgement feedback mode of a network having multiple TAGs configured per serving cell and multiple CORESET pool index values configured per BWP according to the aspects described herein. In the illustrated aspect, UE 115, within the execution environment of TA determination logic 803, uses the last DCI message received to identify a timing advance from a TAG identified based on the configuration information stored in cell group configuration 801. For example, UE 115 may determine the timing advance based on a TAG identified by a CORESET pool index within cell group configuration 801 associated with the resource over which the last DCI was received, or via a default TAG when a CORESET pool index is not configured in the resource over which the last DCI was received. Additionally, UE 115 may determine the timing advance based on a closed loop index associated with the PUCCH resource identified by a PRI received in the DCI.

At block 404, the UE transmits the PUCCH including a joint ACK/NACK message using the TA, wherein the joint ACK/NACK message includes acknowledgement feedback information for each of the one or more downlink transmissions. Upon detection of downlink transmission, UE 115, under control of controller 280, executes ACK/NACK logic 802. The execution environment of ACK/NACK logic 802 provides UE 115 with the functionality to determine an acknowledgment response for reporting based on the success or failure of UE 115 to receive the downlink transmission from any of the serving base stations. As UE 115 is in a joint ACK/NACK feedback mode, the execution environment of ACK/NACK logic 802 allows UE 115 to generate an ACK/NACK feedback message that includes the acknowledgement information determined for each downlink transmission detected by UE 115. Once the timing advance is determined by UE 115 as a result of the execution environment of TA determination logic 803, UE 115 may transmit the joint ACK/NACK feedback message in a PUCCH according to the determined timing advance, via wireless radios 800a-r and antennas 252a-r.

As described with reference to FIG. 4, the present disclosure provides techniques for determining timing advance for a PUCCH in a joint acknowledgement feedback mode of a network having multiple TAGs configured per serving cell and multiple CORESET pool index values configured per BWP. Such techniques all UE acknowledgement information to be transmitted more efficiently when operating in a joint ACK/NACK mode in a serving cell having multiple TAGs configured per serving cell and multiple CORESET pool index values configured per BWP/CC.

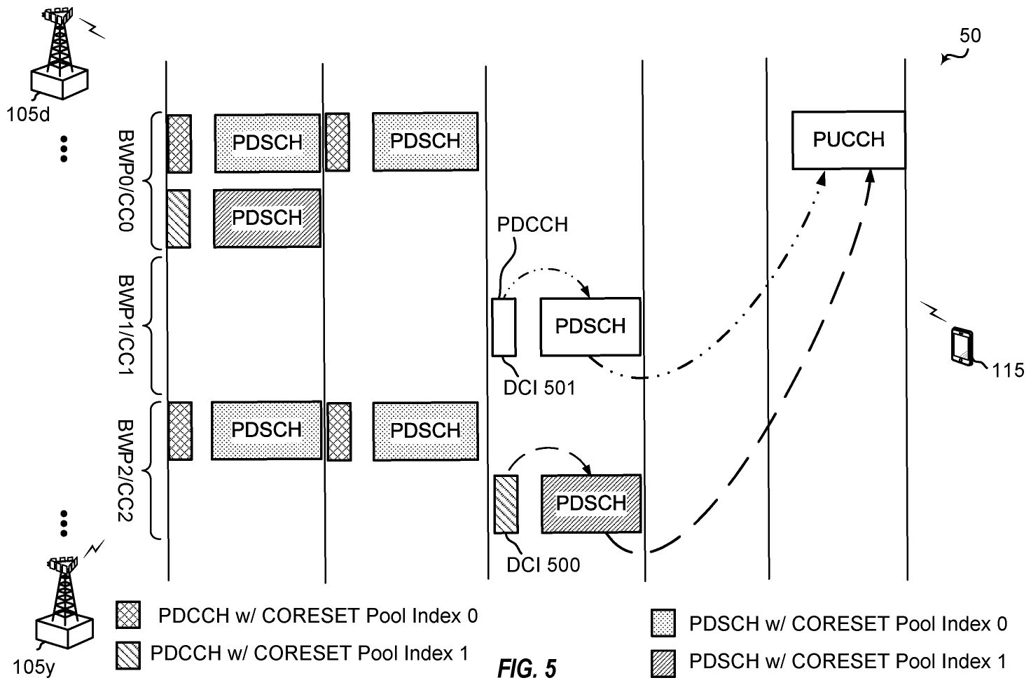

FIG. 5 is a block diagram illustrating wireless network 50 that supports determination of timing advance for a PUCCH in a joint acknowledgement feedback mode of a network having multiple TAGs configured per serving cell and multiple CORESET pool index values configured per BWP according to one or more aspects. In some examples, wireless communications system 50 may implement aspects of wireless network 100. Wireless communications system 50 includes UE 115 and multiple base stations, of which base stations 105d-105y are illustrated. In some implementations, wireless communications system 50 implements a 5G NR network. For example, wireless communications system 50 may include multiple 5G-capable UEs, such as UE 115 and multiple 5G-capable base stations, such as base stations 105d through 105y, configured to operate in accordance with a 5G NR network protocol such as that defined by the 3GPP.

The illustrated snapshot of wireless network 50 shows BWP0/CC0-BWP2/CC2 providing communication resources between UE 115 and base stations 105d-105y serving UE 115. Any of base stations 105d-105y in communication with UE 115 may provide PDCCH including DCI messages scheduling the downlink transmissions, PDSCH. Depending on the BWP/CC, the PDSCH from base stations 105d-105y may be transmitted on the resources configured for the BWP/CC or on predetermined segment of resources configured for the BWP/CC. As illustrated in FIG. 5, BWP0/CC0 and BWP2/CC2 may have PDCCH and PDSCH associated with CORESET pool index 0 and PDCCH and PDSCH associated with CORESET pool index 1, while BWP1/CC1 may have PDCCH and PDSCH that are not associated with a CORESET pool index.

It should be noted that if BWP1/CC1 is configured for communications with multiple base stations and configured with multiple TAGs per serving cell, it may be configured with no CORESET pool index value for some of the active BWPs of the serving cell and at least with a second CORESET pool index (e.g., CORESET pool index 1) for other of the active BWPs of the serving cell.

According to a first aspect of the present disclosure, UE 115 uses the last DCI received in time which schedules a PDSCH subject to the joint ACK/NACK feedback mode to determine the timing advance for its PUCCH that includes a joint ACK/NACK including the acknowledgement information for each PDSCH identified by UE 115 received over BWP0/CC0-BWP2/CC2. For example, in a first scenario, DCI 500, received via BWP2/CC2, is the last DCI received in time, and, thus, UE 115 uses DCI 500 as the determining DCI for the timing advance for PUCCH. In a second scenario, DCI 501, received via BWP1/CC1, is the last DCI received in time and used as the determining DCI for the timing advance for PUCCH.

In a first alternative implementation, UE 115 may use the identification of the CORESET, via the CORESET pool index configured for the BWP/CC on which the determining DCI is received, to determine the timing advance for the PUCCH. For example, in the first scenario noted above, UE 115 may identify the CORESET pool index associated with BWP2/CC2 on which DCI 500 is received. Because BWP2/CC2 is configured with multiple CORESET pool index values, UE 115 determines whether DCI 500 is received in the CORESET of BWP2/CC2 configured with a first CORESET pool index or the CORESET of BWP2/CC2 configured with a second CORESET pool index. In addition, the serving cell that includes BWP0/CC0, on which the PUCCH is transmitted, is configured with multiple TAGs. UE 115 will select the timing advance in the TAG associated with the CORESET pool index over which DCI 500 is received.

Of the multiple BWP/CC configured, some BWP/CC may be configured with no CORESET pool index. Such BWP/CC may be served by one or multiple base stations. In such a scenario, UE 115 would identify the BWP/CC on which the determining DCI is received, determine that this BWP/CC is not configured with a CORESET pool index, and, thus, select a predetermined or default timing advance for the PUCCH. For example, in the second scenario noted above, UE 115 identifies that DCI 501 was received via BWP1/CC1 and determines that BWP1/CC1 was not configured with a CORESET pool index. In such a scenario, UE 115 selects a default timing advance for PUCCH transmission. The default timing advance may correspond to a first TAG configured for the serving cell on which the PUCCH is transmitted, the lowest TAG configured, or any other designated or predetermined TAG associated with the serving cell on which the PUCCH is transmitted.

In a second alternative implementation, UE 115 may determine the timing advance using the closed-loop index associated with the PUCCH resource indicated by the PUCCH resource indicator (PRI) of the determining DCI. As noted above, a UE can be configured via RRC messaging with a list of spatial relations for PUCCH and each spatial relation can be associated with a closed-loop index. The PRI of the determining DCI will identify which PUCCH resource is to be used which would correspond to a spatial relation from the configured list, which is associated with a closed-loop index. Accordingly, in the first scenario noted above, UE 115 has received DCI 500 last in time and uses it as the determining DCI. UE 115 may then determine the PUCCH resource to use via the PRI contained in DCI 500 and identify the spatial relation associated with the indicated PUCCH resource and the closed-loop index associated with the spatial relation. UE 115 may then use the closed-loop index to select the timing advance for the PUCCH from the TAG that would be associated with the closed-loop index.

FIG. 6 is a flow diagram illustrating an example process 600 that supports determination of timing advance for a PUCCH in a joint acknowledgement feedback mode of a network having multiple TAGs configured per serving cell and multiple CORESET pool index values configured per BWP according to one or more aspects. Process 600 may be described with respect to FIG. 8. Operations of process 600 may be performed by a UE, such as UE 115 described above with reference to FIG. 1, 2, or 8. For example, example operations (also referred to as “blocks”) of process 600 may enable UE 115 to support determination of timing advance for a PUCCH in a joint acknowledgement feedback mode of a network having multiple TAGs configured per serving cell and multiple CORESET pool index values configured per BWP.

At block 601, a UE receives a radio resource configuration message, wherein the radio resource configuration message includes at least a feedback mode configuration configuring a joint ACK/NACK feedback mode, a TAG configuration for each serving cell of a plurality of serving cells, wherein at least one serving cell of the plurality of serving cells is configured with a plurality of TAGs, and either zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. As noted above, a UE, such as UE 115, receives the radio resource configuration message via antennas 252a-r and wireless radios 800a-r and stores this configuration information, including the joint ACK/NACK feedback mode, TAG configuration, and any CORESET pool indices, at cell group configuration 801 in memory 280.

At block 602, the UE receives one or more downlink transmissions subject to the joint ACK/NACK feedback mode via one or more downlink resources. As noted above, UE 115 may receive downlink transmissions via a serving cell, such as through PDSCH.

At block 603, the UE determines a timing advance for a PUCCH using a predetermined TAG of the plurality of TAGs. The execution environment of TA determination logic 803 implements the functionality of UE 115 for determination of a timing advance for a PUCCH in a joint acknowledgement feedback mode of a network having multiple TAGs configured per serving cell and multiple CORESET pool index values configured per BWP according to the aspects described herein. In the illustrated aspect, UE 115, within the execution environment of TA determination logic 803, may determine the timing advance from a predetermined TAG, wherein the predetermined TAG may include the first TAG configured for the serving cell a lowest TAG ID of the TAGs configured for the serving cell, the TAG configured via RRC signaling, or the like.

At block 604, the UE transmits the PUCCH including a joint ACK/NACK message using the TA, wherein the joint ACK/NACK message includes acknowledgement feedback information for each of the one or more downlink transmissions. Upon detection of downlink transmissions, UE 115, under control of controller 280, executes ACK/NACK logic 802. The execution environment of ACK/NACK logic 802 provides UE 115 with the functionality to determine an acknowledgment response for reporting based on the success or failure of UE 115 to receive the downlink transmission from any of the serving base stations. As UE 115 is in a joint ACK/NACK feedback mode, the execution environment of ACK/NACK logic 802 allows UE 115 to generate an ACK/NACK feedback message that includes the acknowledgement information determined for each downlink transmission detected by UE 115. Once the timing advance is determined by UE 115 as a result of the execution environment of TA determination logic 803, UE 115 may transmit the joint ACK/NACK feedback message in a PUCCH according to the determined timing advance, via wireless radios 800a-r and antennas 252a-r.

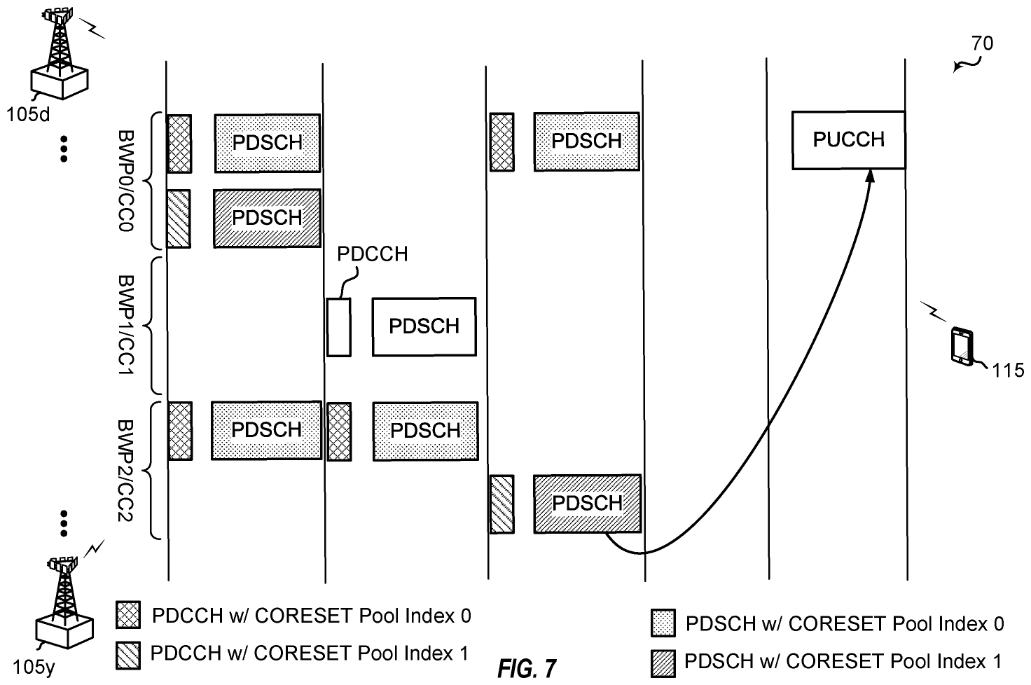

FIG. 7 is a block diagram illustrating wireless network 70 that supports determination of timing advance for a PUCCH in a joint acknowledgement feedback mode of a network having multiple TAGs configured per serving cell and multiple CORESET pool index values configured per BWP according to one or more aspects. In some examples, wireless communications system 70 may implement aspects of wireless network 100. Wireless communications system 70 includes UE 115 and multiple base stations, of which base stations 105d-105y are illustrated. In some implementations, wireless communications system 70 implements a 5G NR network. For example, wireless communications system 70 may include multiple 5G-capable UEs, such as UE 115 and multiple 5G-capable base stations, such as base stations 105d through 105y, configured to operate in accordance with a 5G NR network protocol such as that defined by the 3GPP.

The illustrated snapshot of wireless network 70 shows BWP0/CC0-BWP2/CC2 providing communication resources between UE 115 and base stations 105d-105y serving UE 115. Any of base stations 105d-105y in communication with UE 115 may provide PDCCH including DCI messages scheduling the downlink transmissions, PDSCH. Depending on the BWP/CC, the PDSCH from base stations 105d-105y may be transmitted on the resources configured for the BWP/CC or on predetermined segment of resources configured for the BWP/CC. As illustrated in FIG. 7, BWP0/CC0 and BWP2/CC2 may have PDCCH and PDSCH associated with CORESET pool index 0 and PDCCH and PDSCH associated with CORESET pool index 1, while BWP1/CC1 may have PDCCH and PDSCH that are not associated with a CORESET pool index.

According to a second aspect of the present disclosure, UE 115 uses a timing advance for the PUCCH determined using a predetermined TAG for the serving cell. For example, the predetermined TAG may be the first TAG identifier (ID) of the multiple TAGs configured for the serving cell on which the PUCCH is transmitted, the lowest TAG ID of the configured TAGs, or the TAG configured via RRC messaging. UE 115 would use the timing advance from this predetermined TAG for PUCCH transmission. The PUCCH with a joint ACK/NACK message would, thus, be associated with a fixed base station that corresponds to the predetermined TAG.

In one or more aspects, techniques for supporting determination of timing advance for a PUCCH in a joint acknowledgement feedback mode of a network having multiple TAGs configured per serving cell and multiple CORESET pool index values configured per BWP may include additional aspects, such as any single aspect or any combination of aspects described below or in connection with one or more other processes or devices described elsewhere herein. In one or more aspects, supporting determination of timing advance for a PUCCH in a joint acknowledgement feedback mode of a network having multiple TAGs configured per serving cell and multiple CORESET pool index values configured per BWP may include an apparatus configured to receive a radio resource configuration message, wherein the radio resource configuration message includes at least a feedback mode configuration configuring a joint ACK/NACK feedback mode, a TAG configuration for each serving cell of a plurality of serving cells, wherein at least one serving cell of the plurality of serving cells is configured with a plurality of TAGs, and either zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The apparatus is further configured to receive one or more downlink transmissions via one or more downlink resources, wherein each of the one or more downlink transmissions is scheduled by a DCI message and subject to the joint ACK/NACK feedback mode, determine a timing advance for a PUCCH using a determining DCI message, wherein the determining DCI message corresponds to the DCI message received last in time of the DCI message scheduling each of the one or more downlink transmissions, and transmit the PUCCH including a joint ACK/NACK message using the TA, wherein the joint ACK/NACK message includes acknowledgement feedback information for each of the one or more downlink transmissions.

The apparatus may alternatively be configured to receive a radio resource configuration message, wherein the radio resource configuration message includes at least a feedback mode configuration configuring a joint ACK/NACK feedback mode, and a TAG configuration for each serving cell of a plurality of serving cells, wherein at least one serving cell of the plurality of serving cells is configured with a plurality of TAGs, and either zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell. The apparatus may further be configured to receive one or more downlink transmissions subject to the joint ACK/NACK feedback mode via one or more downlink resources, determining, by the UE, a timing advance for a PUCCH using a predetermined TAG of the plurality of TAGs, and transmitting, by the UE, the PUCCH including a joint ACK/NACK message using the TA, wherein the joint ACK/NACK message includes acknowledgement feedback information for each of the one or more downlink transmissions. Additionally, the apparatus may perform or operate according to one or more aspects as described below.

In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a first aspect, a method of wireless communication performed by a UE includes receiving, by the UE, a radio resource configuration message, wherein the radio resource configuration message includes at least: a feedback mode configuration configuring a joint ACK/NACK feedback mode, a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; receiving, by the UE, one or more downlink transmissions via one or more downlink resources, wherein each of the one or more downlink transmissions is scheduled by a DCI message and subject to the joint ACK/NACK feedback mode; determining, by the UE, a TA for a PUCCH using a determining DCI message, wherein the determining DCI message corresponds to the DCI message received last in time of the DCI message scheduling each of the one or more downlink transmissions; and transmitting, by the UE, the PUCCH including a joint ACK/NACK message using the TA, wherein the joint ACK/NACK message includes acknowledgement feedback information for each of the one or more downlink transmissions.

In a second aspect, alone or in combination with the first aspect, wherein the determining the TA includes: identifying a CORESET pool index value of the at least one CORESET pool index that is associated with a BWP of the plurality of BWPs on which the determining DCI message is received; and selecting the TA based on the CORESET pool index value of the determining DCI message

In a third aspect, alone or in combination with one or more of the first aspect or the second aspect, wherein the selecting the TA includes: selecting the TA associated with a first TAG configured for a serving cell of the plurality of serving cells in response to the CORESET pool index value identified corresponding to a first value, wherein the serving cell corresponds to one of the at least one serving cell with the plurality of TAGs and carries the PUCCH; and selecting the TA associated with a second TAG configured for the serving cell in response to the CORESET pool index value identified corresponding to a second value.

In a fourth aspect, alone or in combination with one or more of the first aspect through the third aspect, wherein the selecting the TA further includes: selecting the TA associated with a predetermined TAG in response to one of: a serving cell of the plurality of serving cells that carries the PUCCH corresponds to one of the at least one serving cell configured with the plurality of TAGs and further corresponds to the BWP on which the determining DCI is received having the zero CORESET pool index value, or the serving cell carrying the PUCCH corresponds to one of the plurality of serving cells configured with a single TAG.

In a fifth aspect, alone or in combination with one or more of the first aspect through the fourth aspect, wherein the determining the TA includes: determining a closed loop index value associated with spatial relation information of a PUCCH resource indicated by a PRI in the determining DCI message; and selecting the TA based on the closed loop index value associated with the PUCCH resource indicated by the PRI.

In a sixth aspect, alone or in combination with one or more of the first aspect through the fifth aspect, wherein the selecting the TA includes: selecting the TA associated with a first TAG configured for a serving cell in response to the closed loop index value identified corresponding to a first value, wherein the serving cell corresponds to one of the at least one serving cell configured with the plurality of TAGs and carries the PUCCH; and selecting the TA associated with a second TAG configured for the serving cell in response to the closed loop index value identified corresponding to a second value.

A seventh aspect includes a method of wireless communication performed by a UE including receiving, by the UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; receiving, by the UE, one or more downlink transmissions subject to the joint ACK/NACK feedback mode via one or more downlink resources; determining, by the UE, a TA for a PUCCH using a predetermined TAG of the plurality of TAGs; and transmitting, by the UE, the PUCCH including a joint ACK/NACK message using the TA, wherein the joint ACK/NACK message includes acknowledgement feedback information for each of the one or more downlink transmissions.

In an eighth aspect, alone or in combination with the seventh aspect, wherein the predetermined TAG includes one of: a first TAG identified in the plurality of TAGS; or a lowest TAG of the plurality of TAGs; or a configured TAG configured via one or more RRC messages received at the UE; or a fixed TAG preprogrammed to the UE in accordance with a current standard.

A ninth aspect may include a UE configured for wireless communication, the UE including at least one processor; and a memory coupled to the at least one processor, wherein the at least one processor is configured: to receive, by the UE, a radio resource configuration message, wherein the radio resource configuration message includes at least: a feedback mode configuration configuring a joint ACK/NACK feedback mode, a TAG configuration for each serving cell of a plurality of serving cells, wherein at least one serving cell of the plurality of serving cells is configured with a plurality of TAGS, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; to receive, by the UE, one or more downlink transmissions via one or more downlink resources, wherein each of the one or more downlink transmissions is scheduled by a DCI message and subject to the joint ACK/NACK feedback mode; to determine, by the UE, a TA for a PUCCH using a determining DCI message, wherein the determining DCI message corresponds to the DCI message received last in time of the DCI message scheduling each of the one or more downlink transmissions; and to transmit, by the UE, the PUCCH including a joint ACK/NACK message using the TA, wherein the joint ACK/NACK message includes acknowledgement feedback information for each of the one or more downlink transmissions.

In a tenth aspect, alone or in combination with the ninth aspect, wherein the configuration of the at least one processor to determine the TA includes configuration of the at least one processor: to identify a CORESET pool index value of the at least one CORESET pool index that is associated with a BWP of the plurality of BWPs on which the determining DCI message is received; and to select the TA based on the CORESET pool index value of the determining DCI message.

In an eleventh aspect, alone or in combination with one or more of the ninth aspect or the tenth aspect, wherein the configuration of the at least one processor to select the TA includes configuration of the at least one processor: to select the TA associated with a first TAG configured for a serving cell of the plurality of serving cells in response to the CORESET pool index value identified corresponding to a first value, wherein the serving cell corresponds to one of the at least one serving cell with the plurality of TAGs and carries the PUCCH; and to select the TA associated with a second TAG configured for the serving cell in response to the CORESET pool index value identified corresponding to a second value.

In a twelfth aspect, alone or in combination with one or more of the ninth aspect through the eleventh aspect, wherein the configuration of the at least one processor to select the TA further includes configuration of the at least one processor: to select the TA associated with a predetermined TAG in response to one of: a serving cell of the plurality of serving cells that carries the PUCCH corresponds to one of the at least one serving cell configured with the plurality of TAGs and further corresponds to the BWP on which the determining DCI is received having the zero CORESET pool index value, or the serving cell carrying the PUCCH corresponds to one of the plurality of serving cells configured with a single TAG.

In a thirteenth aspect, alone or in combination with one or more of the ninth aspect through the twelfth aspect, wherein the configuration of the at least one processor to determine the TA includes configuration of the at least one processor: to determine a closed loop index value associated with spatial relation information of a PUCCH resource indicated by a PRI in the determining DCI message; and to select the TA based on the closed loop index value associated with the PUCCH resource indicated by the PRI.

In a fourteenth aspect, alone or in combination with the ninth aspect through the thirteenth aspect, wherein the configuration of the at least one processor to select the TA includes configuration of the at least one processor: to select the TA associated with a first TAG configured for a serving cell in response to the closed loop index value identified corresponding to a first value, wherein the serving cell corresponds to one of the at least one serving cell configured with the plurality of TAGs and carries the PUCCH; and to select the TA associated with a second TAG configured for the serving cell in response to the closed loop index value identified corresponding to a second value.

A fifteenth aspect may include a UE configured for wireless communication, the UE including at least one processor; and a memory coupled to the at least one processor, wherein the at least one processor is configured: to receive, by the UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; to receive, by the UE, one or more downlink transmissions subject to the joint ACK/NACK feedback mode via one or more downlink resources; to determine, by the UE, a TA for a PUCCH using a predetermined TAG of the plurality of TAGs; and to transmit, by the UE, the PUCCH including a joint ACK/NACK message using the TA, wherein the joint ACK/NACK message includes acknowledgement feedback information for each of the one or more downlink transmissions.

In a sixteenth aspect, alone or in combination with the fifteenth aspect, wherein the predetermined TAG includes one of: a first TAG identified in the plurality of TAGS; or a lowest TAG of the plurality of TAGs; or a configured TAG configured via one or more RRC messages received at the UE; or a fixed TAG preprogrammed to the UE in accordance with a current standard.

A seventeenth aspect may include a UE configured for wireless communication, comprising: means for receiving, by the UE, a radio resource configuration message, wherein the radio resource configuration message includes at least: a feedback mode configuration configuring a joint ACK/NACK feedback mode, a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; means for receiving, by the UE, one or more downlink transmissions via one or more downlink resources, wherein each of the one or more downlink transmissions is scheduled by a DCI message and subject to the joint ACK/NACK feedback mode; means for determining, by the UE, a TA for a PUCCH using a determining DCI message, wherein the determining DCI message corresponds to the DCI message received last in time of the DCI message scheduling each of the one or more downlink transmissions; and means for transmitting, by the UE, the PUCCH including a joint ACK/NACK message using the TA, wherein the joint ACK/NACK message includes acknowledgement feedback information for each of the one or more downlink transmissions.

In an eighteenth aspect, alone or in combination with the seventeenth aspect, wherein the means for determining the TA includes: means for identifying a CORESET pool index value of the at least one CORESET pool index that is associated with a BWP of the plurality of BWPs on which the determining DCI message is received; and means for selecting the TA based on the CORESET pool index value of the determining DCI message.

In a nineteenth aspect, alone or in combination with one or more of the seventeenth aspect or the eighteenth aspect, wherein the means for selecting the TA includes: means for selecting the TA associated with a first TAG configured for a serving cell of the plurality of serving cells in response to the CORESET pool index value identified corresponding to a first value, wherein the serving cell corresponds to one of the at least one serving cell with the plurality of TAGs and carries the PUCCH; and means for selecting the TA associated with a second TAG configured for the serving cell in response to the CORESET pool index value identified corresponding to a second value.

In a twentieth aspect, alone or in combination with one or more of the seventeenth aspect through the nineteenth aspect, wherein the means for selecting the TA further includes: means for selecting the TA associated with a predetermined TAG in response to one of: a serving cell of the plurality of serving cells that carries the PUCCH corresponds to one of the at least one serving cell configured with the plurality of TAGs and further corresponds to the BWP on which the determining DCI is received having the zero CORESET pool index value, or the serving cell carrying the PUCCH corresponds to one of the plurality of serving cells configured with a single TAG.

In a twenty-first aspect, alone or in combination with one or more of the seventeenth aspect through the twentieth aspect, wherein the means for determining the TA includes: means for determining a closed loop index value associated with spatial relation information of a PUCCH resource indicated by a PRI in the determining DCI message; and means for selecting the TA based on the closed loop index value associated with the PUCCH resource indicated by the PRI.

In a twenty-second aspect, alone or in combination with one or more of the seventeenth aspect through the twenty-first aspect, wherein the means for selecting the TA includes: means for selecting the TA associated with a first TAG configured for a serving cell in response to the closed loop index value identified corresponding to a first value, wherein the serving cell corresponds to one of the at least one serving cell configured with the plurality of TAGs and carries the PUCCH; and means for selecting the TA associated with a second TAG configured for the serving cell in response to the closed loop index value identified corresponding to a second value.

A twenty-third aspect may include a UE configured for wireless communication, comprising: means for receiving, by the UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; means for receiving, by the UE, one or more downlink transmissions subject to the joint ACK/NACK feedback mode via one or more downlink resources; means for determining, by the UE, a TA for a PUCCH using a predetermined TAG of the plurality of TAGs; and means for transmitting, by the UE, the PUCCH including a joint ACK/NACK message using the TA, wherein the joint ACK/NACK message includes acknowledgement feedback information for each of the one or more downlink transmissions.

In a twenty-fourth aspect, alone or in combination with the twenty-third aspect, wherein the predetermined TAG includes one of: a first TAG identified in the plurality of TAGS; or a lowest TAG of the plurality of TAGs; or a configured TAG configured via one or more RRC messages received at the UE; or a fixed TAG preprogrammed to the UE in accordance with a current standard.

A twenty-fifth aspect may include a non-transitory computer-readable medium having program code recorded thereon. The program code includes program code executable by a computer for causing the computer to receive, by the UE, a radio resource configuration message, wherein the radio resource configuration message includes at least: a feedback mode configuration configuring a joint acknowledgement ACK/NACK feedback mode, a TAG configuration for each serving cell of a plurality of serving cells, wherein at least one serving cell of the plurality of serving cells is configured with a plurality of TAGS, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; program code executable by the computer for causing the computer to receive, by the UE, one or more downlink transmissions via one or more downlink resources, wherein each of the one or more downlink transmissions is scheduled by a DCI message and subject to the joint ACK/NACK feedback mode; program code executable by the computer for causing the computer to determine, by the UE, a TA for a PUCCH using a determining DCI message, wherein the determining DCI message corresponds to the DCI message received last in time of the DCI message scheduling each of the one or more downlink transmissions; and program code executable by the computer for causing the computer to transmit, by the UE, the PUCCH including a joint ACK/NACK message using the TA, wherein the joint ACK/NACK message includes acknowledgement feedback information for each of the one or more downlink transmissions.

In a twenty-sixth aspect, alone or in combination with the twenty-fifth aspect, wherein the program code executable by the computer for causing the computer to determine the TA includes program code executable by the computer for causing the computer: to identify a CORESET pool index value of the at least one CORESET pool index that is associated with a BWP of the plurality of BWPs on which the determining DCI message is received; and to select the TA based on the CORESET pool index value of the determining DCI message.

In a twenty-seventh aspect, alone or in combination with one or more of the twenty-fifth aspect or the twenty-sixth aspect, wherein the program code executable by the computer for causing the computer to select the TA includes program code executable by the computer for causing the computer: to select the TA associated with a first TAG configured for a serving cell of the plurality of serving cells in response to the CORESET pool index value identified corresponding to a first value, wherein the serving cell corresponds to one of the at least one serving cell with the plurality of TAGs and carries the PUCCH; and to select the TA associated with a second TAG configured for the serving cell in response to the CORESET pool index value identified corresponding to a second value.

In a twenty-eighth aspect, alone or in combination with one or more of the twenty-fifth aspect through the twenty-seventh aspect, wherein the program code executable by the computer for causing the computer to select the TA further includes program code executable by the computer for causing the computer: to select the TA associated with a predetermined TAG in response to one of: a serving cell of the plurality of serving cells that carries the PUCCH corresponds to one of the at least one serving cell configured with the plurality of TAGs and further corresponds to the BWP on which the determining DCI is received having the zero CORESET pool index value, or the serving cell carrying the PUCCH corresponds to one of the plurality of serving cells configured with a single TAG.

In a twenty-ninth aspect, alone or in combination with one or more of the twenty-fifth aspect through the twenty-eighth aspect, wherein the program code executable by the computer for causing the computer to determine the TA includes program code executable by the computer for causing the computer: to determine a closed loop index value associated with spatial relation information of a PUCCH resource indicated by a PRI in the determining DCI message; and to select the TA based on the closed loop index value associated with the PUCCH resource indicated by the PRI.

In a thirtieth aspect, alone or in combination with one or more of the twenty-fifth aspect through the twenty-ninth aspect, wherein the program code executable by the computer for causing the computer to select the TA includes program code executable by the computer for causing the computer: to select the TA associated with a first TAG configured for a serving cell in response to the closed loop index value identified corresponding to a first value, wherein the serving cell corresponds to one of the at least one serving cell configured with the plurality of TAGs and carries the PUCCH; and to select the TA associated with a second TAG configured for the serving cell in response to the closed loop index value identified corresponding to a second value.

A thirty-first aspect may include a non-transitory computer-readable medium having program code recorded thereon. The program code includes program code executable by a computer for causing the computer to receive, by the UE, a radio resource configuration message, wherein the radio resource configuration message includes at least: a feedback mode configuration configuring a joint ACK/NACK feedback mode, and a TAG configuration for each serving cell of a plurality of serving cells, wherein at least one serving cell of the plurality of serving cells is configured with a plurality of TAGs, and one of: zero CORESET pool index value and a second CORESET pool index for second CORESETs configured on one or more active BWPs of the at least one serving cell, or a first CORESET pool index for first CORESETs configured on one or more additional active BWPs of the at least one serving cell and the second CORESET pool index for the second CORESETs configured on the one or more active BWPs of the at least one serving cell; program code executable by the computer for causing the computer to receive, by the UE, one or more downlink transmissions subject to the joint ACK/NACK feedback mode via one or more downlink resources; program code executable by the computer for causing the computer to determine, by the UE, a TA for a PUCCH using a predetermined TAG of the plurality of TAGs; and program code executable by the computer for causing the computer to transmit, by the UE, the PUCCH including a joint ACK/NACK message using the TA, wherein the joint ACK/NACK message includes acknowledgement feedback information for each of the one or more downlink transmissions.

In a thirty-second aspect, alone or in combination with the thirty-first aspect, wherein the predetermined TAG includes one of: a first TAG identified in the plurality of TAGS; or a lowest TAG of the plurality of TAGs; or a configured TAG configured via one or more RRC messages received at the UE; or a fixed TAG preprogrammed to the UE in accordance with a current standard.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed at a user equipment (UE), the method comprising:
receiving, by the UE, a radio resource configuration message, wherein the radio resource configuration message includes at least:
a feedback mode configuration configuring a joint acknowledgement (ACK)/negative acknowledgement (NACK) feedback mode,
a timing advance group (TAG) configuration for each serving cell of a plurality of serving cells, wherein at least one serving cell of the plurality of serving cells is configured with a plurality of TAGs, and
one of:
zero control resource set (CORESET) pool index value and a second CORESET pool index for second CORESETs configured on one or more active bandwidth parts (BWPs) of the at least one serving cell, or
a first CORESET pool index for first CORESETs configured on one or more additional active BWPs of the at least one serving cell and the second CORESET pool index for the second CORESETs configured on the one or more active BWPs of the at least one serving cell;
receiving, by the UE, one or more downlink transmissions via one or more downlink resources, wherein each of the one or more downlink transmissions is scheduled by a downlink control information (DCI) message and subject to the joint ACK/NACK feedback mode; and
transmitting, by the UE, a physical uplink control channel (PUCCH) including a joint ACK/NACK message using a timing advance (TA) identified in accordance with the DCI message received last-in-time of the DCI message that schedule each of the one or more downlink transmissions, wherein the joint ACK/NACK message includes acknowledgement feedback information for each of the one or more downlink transmissions.

2. The method of claim 1, further including:
identifying a CORESET pool index value of one of the first CORESET pool index or the second CORESET pool index that is associated with a BWP of the one or more active BWPs on which the DCI message received last-in-time of the DCI message that schedule each of the one or more downlink transmissions is received; and
selecting the TA based on the CORESET pool index value of the DCI message received last-in-time of the DCI message that schedule each of the one or more downlink transmissions.

3. The method of claim 2, wherein the selecting the TA includes:
selecting the TA associated with a first TAG configured for a serving cell of the plurality of serving cells in response to the CORESET pool index value identified corresponding to a first value, wherein the serving cell corresponds to one of the at least one serving cell with the plurality of TAGs and carries the PUCCH.

4. The method of claim 2, wherein the selecting the TA further includes:
selecting the TA associated with a predetermined TAG in response to
a serving cell of the plurality of serving cells that carries the PUCCH corresponds to one of the at least one serving cell configured with the plurality of TAGs and further corresponds to the BWP on which the DCI message received last-in-time of the DCI message that schedule each of the one or more downlink transmissions is received having the zero CORESET pool index value.

5. The method of claim 1, further including:
identifying a closed loop index value associated with spatial relation information of a PUCCH resource indicated by a PUCCH resource indicator (PRI) in the DCI message received last-in-time of the DCI message that schedule each of the one or more downlink transmissions; and
selecting the TA based on the closed loop index value associated with the PUCCH resource indicated by the PRI.

6. The method of claim 5, wherein the selecting the TA includes:
selecting the TA associated with a first TAG configured for a serving cell in response to the closed loop index value identified corresponding to a first value, wherein the serving cell corresponds to one of the at least one serving cell configured with the plurality of TAGs and carries the PUCCH; and
selecting the TA associated with a second TAG configured for the serving cell in response to the closed loop index value identified corresponding to a second value.

7.-8. (canceled)

9. An apparatus configured for wireless communication at a user equipment (UE), the apparatus comprising:
at least one processor; and
at least one memory coupled to the at least one processor,
wherein the at least one processor is configured:
to receive, by the UE, a radio resource configuration message, wherein the radio resource configuration message includes at least:
a feedback mode configuration configuring a joint acknowledgement (ACK)/negative acknowledgement (NACK) feedback mode,
a timing advance group (TAG) configuration for each serving cell of a plurality of serving cells, wherein at least one serving cell of the plurality of serving cells is configured with a plurality of TAGs, and
one of:
zero control resource set (CORESET) pool index value and a second CORESET pool index for second CORESETs configured on one or more active bandwidth parts (BWPs) of the at least one serving cell, or
a first CORESET pool index for first CORESETs configured on one or more additional active BWPs of the at least one serving cell and the second CORESET pool index for the second CORESETs configured on the one or more active BWPs of the at least one serving cell;
to receive, by the UE, one or more downlink transmissions via one or more downlink resources, wherein each of the one or more downlink transmissions is scheduled by a downlink control information (DCI) message and subject to the joint ACK/NACK feedback mode; and
to transmit, by the UE, a physical uplink control channel (PUCCH) including a joint ACK/NACK message using a timing advance (TA) identified in accordance with the DCI message received last-in-time of the DCI message that schedule each of the one or more downlink transmissions, wherein the joint ACK/NACK message includes acknowledgement feedback information for each of the one or more downlink transmissions.

10. The apparatus of claim 9, wherein the at least one processor is further configured:
to identify a CORESET pool index value of one of the first CORESET pool index or the second CORESET pool index that is associated with a BWP of the one or more active BWPs on which the DCI message received last-in-time of the DCI message that schedule each of the one or more downlink transmissions is received; and
to select the TA based on the CORESET pool index value of the DCI message received last-in-time of the DCI message that schedule each of the one or more downlink transmissions.

11. The apparatus of claim 10, wherein the configuration of the at least one processor to select the TA includes configuration of the at least one processor to:
select the TA associated with a first TAG configured for a serving cell of the plurality of serving cells in response to the CORESET pool index value identified corresponding to a first value, wherein the serving cell corresponds to the at least one serving cell with the plurality of TAGs and carries the PUCCH.

12. The apparatus of claim 10, wherein the configuration of the at least one processor to select the TA further includes configuration of the at least one processor:
to select the TA associated with a predetermined TAG in response to:
a serving cell of the plurality of serving cells that carries the PUCCH corresponds to the at least one serving cell configured with the plurality of TAGs and further corresponds to the BWP on which the DCI message received last-in-time of the DCI message that schedule each of the one or more downlink transmissions is received having the zero CORESET pool index value.

13. The apparatus of claim 9, wherein the at least one processor is further configured:
to identify a closed loop index value associated with spatial relation information of a PUCCH resource indicated by a PUCCH resource indicator (PRI) in the DCI message received last-in-time of the DCI message that schedule each of the one or more downlink transmissions; and
to select the TA based on the closed loop index value associated with the PUCCH resource indicated by the PRI.

14. The apparatus of claim 13, wherein of the at least one processor to select the TA includes configuration of the at least one processor:
to select the TA associated with a first TAG configured for a serving cell in response to the closed loop index value identified corresponding to a first value, wherein the serving cell corresponds to the at least one serving cell configured with the plurality of TAGs and carries the PUCCH; and
to select the TA associated with a second TAG configured for the serving cell in response to the closed loop index value identified corresponding to a second value.

15. An apparatus configured for wireless communication at a user equipment (UE), the apparatus comprising:
at least one processor; and
at least one memory coupled to the at least one processor,
wherein the at least one processor is configured:
to receive, by the UE, a radio resource configuration message, wherein the radio resource configuration message includes at least:
a feedback mode configuration configuring a joint acknowledgement (ACK)/negative acknowledgement (NACK) feedback mode, and
a timing advance group (TAG) configuration for each serving cell of a plurality of serving cells, wherein at least one serving cell of the plurality of serving cells is configured with a plurality of TAGs, and
one of:
zero control resource set (CORESET) pool index value and a second CORESET pool index for second CORESETs configured on one or more active bandwidth parts (BWPs) of the at least one serving cell, or
a first CORESET pool index for first CORESETs configured on one or more additional active BWPs of the at least one serving cell and the second CORESET pool index for the second CORESETs configured on the one or more active BWPs of the at least one serving cell;
to receive, by the UE, one or more downlink transmissions subject to the joint ACK/NACK feedback mode via one or more downlink resources; and
to transmit, by the UE, a physical uplink control channel (PUCCH) including a joint ACK/NACK message using a timing advance (TA) identified in accordance with a predetermined TAG of the plurality of TAGs, wherein the joint ACK/NACK message includes acknowledgement feedback information for each of the one or more downlink transmissions.

16. The apparatus of claim 15, wherein the predetermined TAG includes one of:
a first TAG identified in the plurality of TAGS; or
a lowest TAG of the plurality of TAGs; or
a configured TAG configured via one or more radio resource control (RRC) messages received at the UE; or
a fixed TAG preprogrammed to the UE in accordance with a current standard.

17. The apparatus of claim 15, wherein the PUCCH is transmitted to a fixed serving cell designated within the plurality of serving cells.

18. The method of claim 2, wherein the selecting the TA includes:
selecting the TA associated with a second TAG configured for the serving cell in response to the CORESET pool index value identified corresponding to a second value.

19. The method of claim 2, wherein the selecting the TA further includes:
selecting the TA associated with a predetermined TAG in response to the serving cell carrying the PUCCH corresponds to the plurality of serving cells configured with a single TAG.

20. The apparatus of claim 10, wherein of the at least one processor to select the TA includes configuration of the at least one processor to:
select the TA associated with a second TAG configured for the serving cell in response to the CORESET pool index value identified corresponding to a second value.

21. The apparatus of claim 10, wherein of the at least one processor to select the TA further includes configuration of the at least one processor:
to select the TA associated with a predetermined TAG in response to the serving cell carrying the PUCCH corresponding to the plurality of serving cells configured with a single TAG.
